(19) United States
(12) Patent Application Publication
(10) Pub. No.: US 2006/0086353 A1
(43) Pub. Date: Apr. 27, 2006

(54) Barbecue grill mount for use with vehicle

(76) Inventor: Fred J. Ransford, Grosse Pointe Park, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/252,355

(22) Filed: Oct. 17, 2005

Related U.S. Application Data
(60) Provisional application No. 60/622,308, filed on Oct. 26, 2004.

(51) Int. Cl. F24C 15/00; A47J 37/00

(52) U.S. Cl. 126/37 B; 126/41 R

(57) ABSTRACT

A barbecue grill mount (10) for use with a vehicle (12) includes a hitch tube (20) received by a vehicle hitch receiver tube (16), an elongated support tube (32) that extends laterally from the hitch tube (20), a pivot tube (38) mounted by an outer end (46) of the support tube (32), an inverted L-shaped positioning tube (46) supported for rotational positioning by the pivot tube (38), and a grill tray (60) mounted on a horizontal portion distal end (58) of the positioning tube and adjustably positioned about the pivot tube under a control of a rotational positioner (44) of the pivot tube.

### CROSS-REFERENCE TO RELATED APPLICATIONS

This application claims the benefit of U.S. provisional application Ser. No. 60/622,308, filed Oct. 26, 2004.

### BACKGROUND OF THE INVENTION

1. Field of the Invention

This invention relates to a barbecue grill mount for use with a vehicle to provide mounting of the barbecue grill on a hitch tube at the rear end of vehicle.

2. Background Art

Barbecue grills have previously been mounted for use on vehicle rear hitch tubes. Such hitch tubes have received a component of a grill mount which is detachably inserted therein to provide use of the barbecue grill at tailgate functions, camping outings, and other events where travel and barbecuing adjacent the travel vehicle is done.

Prior art references noted during an investigation conducted in connection with the present invention include: U.S. Pat. No. 5,626,126 McNulty; U.S. Pat. No. 5,640,949 Smith; U.S. Pat. No. 5,950,617 Lorenz; U.S. Pat. No. 6,520,473 Lee; and U.S. Pat. No. 6,588,418 Loving; and United States Patent Application Publications: US 2001/0042545 Robin; US 2004/0040553 McKoski; and US 2004/0112369 LeDue et al.

### SUMMARY OF THE INVENTION

An object of the present invention is to provide an improved mount for mounting a barbecue grill for use with a vehicle and having a construction that is versatile and easy to use as well as being economical to manufacture.

In carrying out the above object, a vehicle barbecue grill mount constructed in accordance with the invention includes a hitch tube of a square cross section. The hitch tube has a front end for insertion into a hitch receiver tube on the rear end of a vehicle and has a rear end that extends rearwardly from the hitch receiver tube after the insertion. An elongated support tube of the mount extends laterally with respect to the vehicle from the mounted hitch tube and has a square cross section. The support tube has an inner end that is mounted by the rear end of the hitch tube and has an outer end located adjacent one lateral side of the vehicle. A pivot tube of the mount has a round cross section and is mounted vertically on the outer end of the support tube. The pivot tube has an upwardly opening upper end and a rotational positioner. An inverted L-shaped positioning tube of the mount has a round cross section. The positioning tube has a vertical portion including an upper end and a lower end received by the upper end of the pivot tube. The positioning tube also includes a horizontal portion that has a connection end supported by the upper end of the vertical portion and a distal end spaced horizontally from the vertical portion. A grill tray is mounted on the distal end of the horizontal portion of the positioning tube and is adjustably positioned about the pivot tube under the control of its rotational positioner.

The grill mount includes a first welded connection between the rear end of the hitch tube and the inner end of the support tube, and the grill mount also includes a second welded connection between the outer end of the support tube and the pivot tube. The pivot tube has a lower crimped end that limits downward movement of the vertical portion of the positioning tube, and the rotational positioner is embodied by at least one threaded T bolt and, more specifically, a pair of threaded T bolt positioners.

The positioning tube includes a 90 degree curved elbow portion that connects the upper end of its vertical portion to the connection end of its horizontal portion. Furthermore, the positioning tube vertical portion, horizontal portion and curved elbow portion have a unitary, one-piece construction.

In addition, the distal end of the horizontal portion of the positioning tube includes a rotatably adjustable connection that supports the grill tray for rotational adjustment about the distal end of the horizontal portion of the positioning tube. The rotatably adjustable connection includes vertical mating tubes on the distal end of the horizontal portion of the positioning tube and on the grill tray, and the rotatably adjustable connection also includes a threaded positioner for adjustably controlling the grill tray rotation.

The grill tray has a formed sheet metal construction of a rectangular shape including upwardly extending side flanges. The grill tray also has a pair of apertures of rectangular shapes.

The objects, features and advantages of the present invention are readily apparent from the following detailed description of the preferred embodiment when taken in connection with the accompanying drawings.

### BRIEF DESCRIPTION OF THE DRAWINGS

FIG. 1 is a perspective view illustrating a barbecue grill mount constructed in accordance with the invention for use with a vehicle that is schematically indicated.

FIG. 2 is a perspective view of the barbecue grill mount similar to FIG. 1 but shown with a grill tray thereof moved to a different position.

FIG. 3 is a top plan view of the barbecue grill mount.

FIG. 4 is an elevational view of the barbecue grill mount taken along the direction of line 4-4 in FIG. 3 looking forwardly with respect to the vehicle.

FIG. 5 is a side elevational view of the barbecue grill mount taken along the direction of line 5-5 in FIG. 4 in a lateral inward direction with respect to the vehicle.

### DETAILED DESCRIPTION OF THE PREFERRED EMBODIMENT

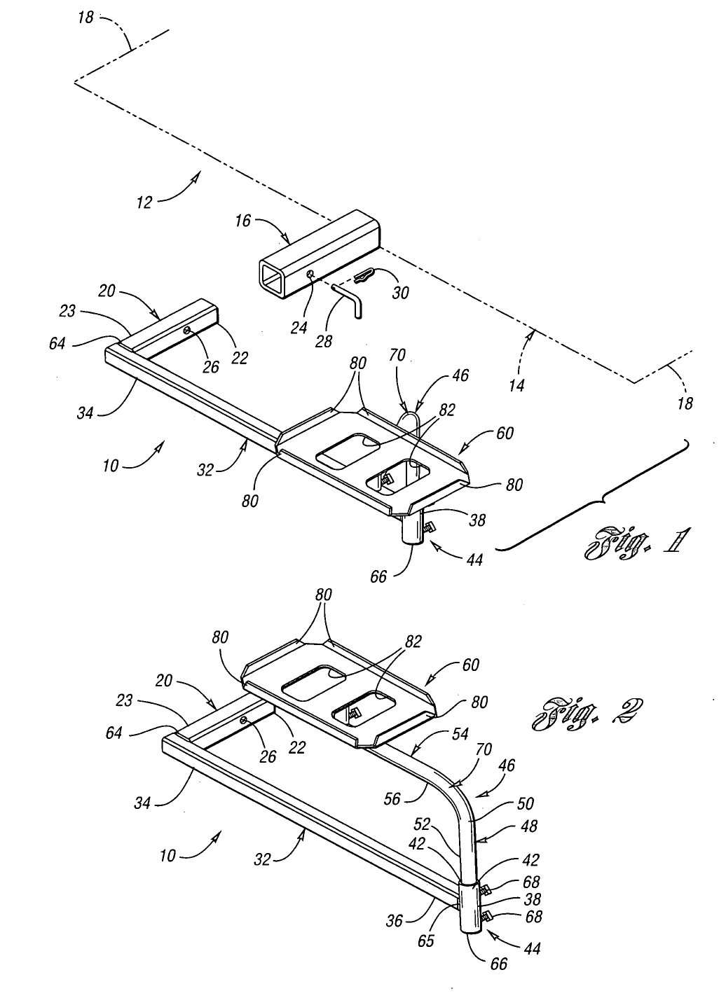

With reference to FIG. 1 of the drawings, a barbecue grill mount constructed in accordance with the present invention is generally indicated by 10 and is usable with a schematically indicated vehicle 12 whose rear end 14 includes a hitch receiver tube 16 of a square cross section that extends longitudinal with respect to the vehicle at a central location between its opposite lateral sides 18.

The barbecue grill mount 10 of the invention as shown in FIG. 1 includes a hitch tube 20 of a square cross section and has front and rear ends 22 and 23. The hitch tube front end 22 is inserted into the vehicle hitch receiver tube 16 so as to extend rearwardly therefrom after such insertion. Furthermore, the hitch receiver tube 16 and the hitch tube 20 have associated holes 24 and 26 that receive an L-shaped locking pin 28 secured by a retainer clip 30 to provide detachable mounting of the grill mount in a manner similar to attachment and detachment of vehicle hitch balls.

As shown in FIGS. 1-4, the barbecue grill mount 10 also includes an elongated support tube 32 that extends laterally with respect to the vehicle from the mounted hitch tube 20 and has a square cross section. This support tube 32 has an inner end 34 that is mounted by the rear end 23 of the hitch tube 20. Support tube 32 also has an outer end 36 that is located adjacent one lateral side 18 of the vehicle 12 shown in FIG. 1.

As best illustrated in FIGS. 2-5, the grill mount 10 also includes a pivot tube 38 having a round cross section and is mounted extending vertically on the outer end 36 of the support tube 32. The pivot tube 38 has an upwardly opening upper end 42 and a rotational positioner 44 whose function is hereinafter described.

As best illustrated in FIGS. 2 and 4, the grill mount 10 also includes an inverted L-shaped positioning tube 46 having a round cross section. This positioning tube 46 has a vertical portion 48 including an upper end 50 and also including a lower end 52 received by the upper end 42 of the pivot tube 38. The positioning tube 46 also has a horizontal portion 54 that has a connection end 56 supported by the upper end 50 of the vertical portion 48 and has a distal end 58 spaced horizontally from the vertical portion.

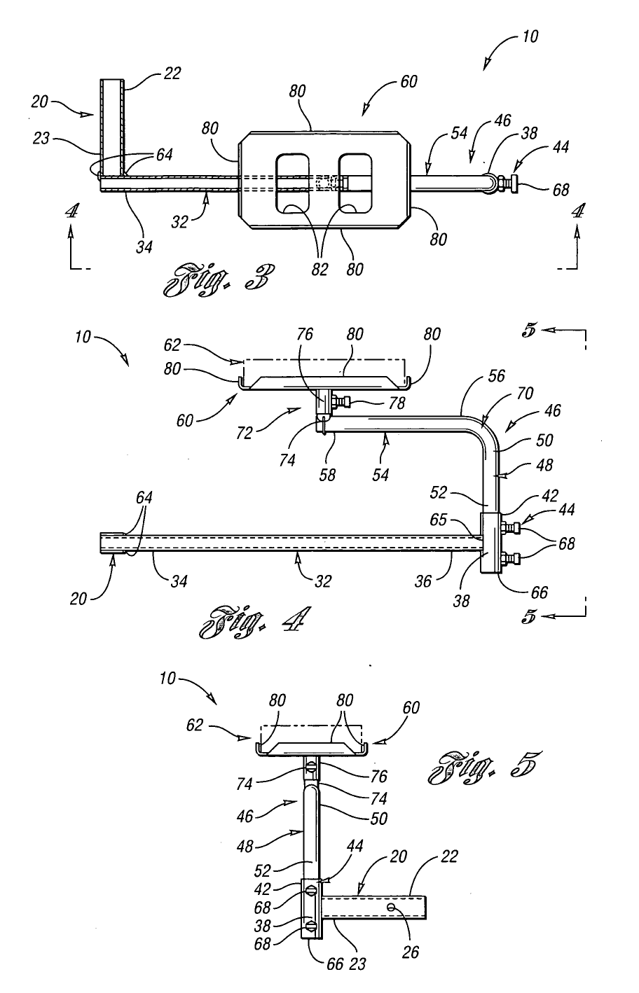

As shown in FIGS. 3-5, a grill tray 60 is mounted on the distal end 58 of the horizontal portion 54 of the positioning tube 46 and is adjustably positioned about the pivot tube 38 under the control of its rotatable positioner 44. The grill tray 60 provides for mounting of a barbecue grill 62 as schematically shown in FIGS. 4 and 5.

As shown in FIGS. 3 and 4, the grill mount 10 includes a first welded connection 64 between the rear end 23 of the hitch tube 20 and the inner end 34 of the support tube 32. The grill mount 10 also includes a second welded connection 65 between the outer end 36 of the support tube 32 and the pivot tube 38.

The grill mount 10 as shown in FIGS. 4 and 5 has its pivot tube 38 provided with a lower end 66 that is crimped inwardly to limit downward movement of the vertical portion 48 of the positioning tube 46. Furthermore, the rotational positioner 44 is embodied by at least one threaded T bolt 68 threaded into a threaded hole in the pivot tube so as to adjustably position the rotational position of the positioning tube 46. More specifically, there are a pair of the threaded T bolt positioners 68 that control the positioning tube location.

As best illustrated in FIGS. 2 and 4, the positioning tube 46 includes a 90 degree curved elbow portion 70 that connects the upper end 50 of its vertical portion 48 to the connection end 56 of its horizontal portion 54. More specifically, the positioning tube vertical portion 48, horizontal portion 54 and curved elbow portion 70 have a unitary, one-piece construction that is bent from a straight tube.

As illustrated in FIGS. 4 and 5, the distal end 58 of the horizontal portion 54 of the positioning tube 46 includes a rotatably adjustable connection 72 that supports the grill tray 60 for rotational adjustment about the distal end of the horizontal portion of the positioning tube. Such rotational adjustment allows the barbecue grill to be positioned in any rotational position despite the rotational adjustment of the positioning tube 46 between different positions as illustrated in FIGS. 1 and 2. Furthermore, the rotatably adjustable connection 72 shown in FIGS. 4 and 5 includes vertically mating tube 74 and 76 on the distal end 58 of the horizontal portion 54 of the positioning tube 46 and on the grill tray 60 at its lower side. In addition, the rotatably adjustable connection 72 includes a threaded positioner 78 for adjustably controlling the grill tray rotation.

The grill tray 60 has a construction formed from sheet metal with a rectangular shape as shown in FIG. 3 and also includes upwardly extending side flanges 80 best shown in FIGS. 4 and 5. In addition, the grill tray as shown in FIG. 3 includes a pair of apertures 82 which have rectangular shapes and are located on opposite sides of the adjustable connection 72 on the lower side of the grill tray.

The square cross-sectioned hitch tube 20 and support tube 32 are made of metal such as cold rolled steel and have a greater thickness than the round cross-sectioned pivot tube 38, positioning tube 46 and connection tubes 74 and 76 which are also made of metal such as cold rolled steel. The grill tray 60 as well as all of the tube components of the grill mount 10 are painted, coated with plastic or otherwise protected.

While the preferred embodiment of the invention has been illustrated and described, it is not intended that this embodiment illustrates and describes all possible forms of the invention. Rather, the words used in the specification are words of description rather than limitation, and it is understood that various changes may be made without departing from the spirit and scope of the invention as defined by the following claims.

What is claimed is:

1. A barbecue grill mount for use with a vehicle, the barbecue grill mount comprising:
a hitch tube of a square cross section and having a front end for insertion into a hitch receiver tube on the rear end of a vehicle and having a rear end that extends rearwardly from the hitch receiver tube after the insertion;
an elongated support tube that extends laterally with respect to the vehicle from the mounted hitch tube and has a square cross section, the support tube having an inner end that is mounted by the rear end of the hitch tube, and the support tube having an outer end located adjacent one lateral side of tie vehicle;
a pivot tube having a round cross section and a connection for mounting thereof vertically on the outer end of the support tube, and the pivot tube having an upwardly opening upper end and a rotational positioner;
an inverted L-shaped positioning tube having a round cross section, the positioning tube having a vertical portion including an upper end and also having a lower end received by the upper end of the pivot tube, and the positioning tube having a horizontal portion that has a connection end supported by the upper end of the vertical portion and having a distal end spaced horizontally from the vertical portion; and
a grill tray mounted on the distal end of the horizontal portion of the positioning tube and being adjustably positioned about the pivot tube under the control of its rotational positioner.

2. A vehicle barbecue grill mount as in claim 1 further including a first welded connection between the outer end of the hitch tube and the inner end of the support tube, and a second welded connection between the outer end of the support tube and the pivot tube.

3. A vehicle barbecue grill mount as in claim 1 wherein the pivot tube has a lower crimped end that limits downward movement of the vertical portion of the positioning tube, and the rotational positioner being embodied by a threaded T bolt.

4. A vehicle barbecue grill mount as in claim 3 which includes a pair of threaded T bolt positioners.

5. A vehicle barbecue grill mount as in claim 1 wherein the positioning tube includes a 90 degree curved elbow portion that connects the upper end of its vertical portion to the connection end of its horizontal portion.

6. A vehicle barbecue grill mount as in claim 5 wherein the positioning tube vertical portion, horizontal portion and curved elbow portion have a unitary one-piece construction.

7. A vehicle barbecue grill mount as in claim 1 wherein the distal end of the horizontal portion of the positioning tube includes a rotatably adjustable connection that supports the grill tray for rotational adjustment about the distal end of the horizontal portion of the positioning tube.

8. A vehicle barbecue grill mount as in claim 7 wherein the rotatably adjustable connection includes vertical mating tubes on the distal end of the horizontal portion of the positioning tube and on the grill tray, and the rotatably adjustable connection also including a threaded positioner for adjustably controlling the grill tray rotation.

9. A vehicle barbecue grill mount as in claim 1 wherein the grill tray is made has a formed sheet metal construction of a rectangular shape including upwardly extending side flanges.

10. A vehicle barbecue grill mount as in claim 9 wherein the grill tray also has a pair of apertures of rectangular shapes.

11. A barbecue grill mount for use with a vehicle, the barbecue grill mount comprising:
a hitch tube of a square cross section and having a front end for insertion into a hitch receiver tube on the rear end of a vehicle and having a rear end that extends rearwardly from the hitch receiver tube after the insertion;
an elongated support tube that extends laterally with respect to the vehicle from the mounted hitch tube and has a square cross section, the support tube having an inner end and a first welded connection to the rear end of the hitch tube, and the support tube having an outer end located adjacent one lateral side of the vehicle;
a pivot tube having a round cross section and a second welded connection for mounting thereof vertically on the outer end of the support tube, and the pivot tube having an upwardly opening upper end, at least one rotational positioner embodied by a T bolt, and a crimped lower end;
an inverted L-shaped positioning tube having a round cross section, the positioning tube having a vertical portion including an upper end and also having a lower end received by the upper end of the pivot tube with its downward movement being limited by the lower crimped end of the pivot tube, and the positioning tube having a horizontal portion that has a connection end supported by the upper end of the vertical portion and having a distal end spaced horizontally from the vertical portion; and
a formed sheet metal grill tray mounted on the distal end of the horizontal portion of the positioning tube and being adjustably positioned about the pivot tube under the control of its rotational T bolt positioner.

12. A barbecue grill mount for use with a vehicle, the barbecue grill mount comprising:
a hitch tube of a square cross section and having a front end for insertion into a hitch receiver tube on the rear end of a vehicle and having a rear end that extends rearwardly from the hitch receiver tube after the insertion;
an elongated support tube that extends laterally with respect to the vehicle from the mounted hitch tube and has a square cross section, the support tube having an inner end and a first welded connection to the rear end of the hitch tube, and the support tube having an outer end located adjacent one lateral side of the vehicle;
a pivot tube having a round cross section and a second welded connection for mounting thereof vertically on the outer end of the support tube, the pivot tube having an upwardly opening upper end and at least one rotational positioner embodied by a T bolt, and the pivot tube having a crimped lower end;
an inverted L-shaped positioning tube having a round cross section, the positioning tube having a vertical portion including an upper end and also having a lower end received by the upper end of the pivot tube with its downward movement being limited by the lower crimped end of the pivot tube, the positioning tube having a 90 degree curved elbow supported by the upper end of its vertical portion and the positioning tube having a horizontal portion that has a connection end supported by the curved elbow on the upper end of the vertical portion and having a distal end spaced horizontally from the vertical portion; and
a formed sheet metal grill tray of a rectangular shape having upwardly extending side flanges and rectangular apertures; and
a rotatably adjustable connection that supports the grill tray on the distal end of the positioning tube for adjustable positioning about the pivot tube under the control of its rotational T bolt positioner, and the rotatably adjustable connection including vertical mating tubes on the distal end of the horizontal portion of the positioning tube and on the grill tray as well as including a threaded positioner for adjustably controlling grill tray rotation about the distal end of the horizontal portion of the positioning tube.
